(19) United States
(12) Patent Application Publication
(10) Pub. No.: US 2007/0023970 A1
(43) Pub. Date: Feb. 1, 2007

(54) Method for producing ferrite sintered magnet

(75) Inventors: Kiyoyuki Masuzawa, Tokyo (JP); Toshinori Miya, Tokyo (JP); Yasumi Takatsuka, Tokyo (JP); Hitoshi Taguchi, Tokyo (JP); Shunsuke Kurasawa, Tokyo (JP)

Correspondence Address: HOGAN & HARTSON L.L.P., 1999 AVENUE OF THE STARS, SUITE 1400, LOS ANGELES, CA, 90067, US

(73) Assignee: TDK CORPORATION

(21) Appl. No.: 11/447,600

(22) Filed: Jun. 5, 2006

(30) Foreign Application Priority Data
Jun. 13, 2005 (JP) 2005-171800

(51) Int. Cl. H01F 1/00; H05B 6/00; B29C 71/04

(52) U.S. Cl. 264/429; 252/62.63; 252/62.57; 252/62.62; 264/427; 264/428

(57) ABSTRACT

There is provided a method for producing a La—Co based ferrite magnet by using a polyhydric alcohol as a dispersant, the method capable of suppressing the composition deviation. The production method is a method for producing an M-type hexagonal ferrite sintered magnet that includes, as main constituents thereof, Fe, an element A (A including at least one element selected from Sr, Ba and Pb), an element R (R including at least one element selected from rare earth elements and Bi, and including La as an essential component) and an element Me (Me including Co or including Co and Zn), the method including a molding step of obtaining a molded body by pressure molding, in a magnetic filed in a predetermined direction, a slurry for molding prepared by dispersing a powder mainly composed of a ferrite in water as a dispersion medium and by adding a dispersant, and a sintering step of obtaining the ferrite sintered magnet by sintering the molded body, wherein when the dispersant is a polyhydric alcohol represented by the general formula Cₙ(OH)ₙHₙ₊₂, the concentration of B in the water to be used for preparing the slurry for molding is set at 1 ppm or less.

### BACKGROUND OF THE INVENTION

1. Field of the Invention

The present invention relates to a ferrite sintered magnet, in particular, a method for producing an M-type ferrite sintered magnet including La and Co.

2. Description of the Related Art

As ferrite magnets used as permanent magnets, generally hexagonal magnetoplumbite-type (M-type) Sr ferrites or Ba ferrites have hitherto been dominantly used. These M-type ferrites are characterized by being relatively low in price and high in magnetic properties, and hence are utilized as sintered magnets and bonded magnets, which are applied to, for example, motors and the like mounted in household electric appliances, automobiles and the like.

Recently, demands for downsizing and performance enhancing of electronic components have been growing, and concomitantly, downsizing and performance enhancing of ferrite sintered magnets have been strongly demanded. U.S. Pat. No. 6,139,766, U.S. Pat. No. 6,258,290, and U.S. Pat. No. 6,908,568 propose ferrite sintered magnets having such high residual magnetic flux densities and such high coercive forces that have not been able to be attained by conventional M-type ferrite sintered magnets. Specifically, U.S. Pat. No. 6,139,766 describes a ferrite sintered magnet made of an oxide sintered body that has a composition represented by the relations that 0.04≦x≦0.9, 0.04≦y≦0.5, 0.4≦x/y≦4.0 and 0.7≦z≦1.2, when represented by a composition formula (1) Sr₁₋ₓLaₓ(Fe_{12-y}CO_{y})_{z}. This ferrite sintered magnet includes at least La and Co, and hence is referred to as La—Co based ferrite magnet.

This La—Co based ferrite magnet has been known to have high magnetic properties, and generally produced by carrying out the steps of wet molding the slurries for molding containing predetermined raw material powders and water each in a magnetic field to yield molded bodies and sintering these molded bodies. In U.S. Pat. No. 6,908,568, the present inventors have presented a proposal for improvement of the magnetic field orientation at the time of this wet molding. This proposal is characterized by employing a slurry for molding added with polyhydric alcohol, as a dispersant, represented by the general formula Cₙ(OH)ₙHₙ₊₂.

### SUMMARY OF THE INVENTION

When the present inventors produced a La—Co based ferrite magnet by using a polyhydric alcohol as a dispersant disclosed in U.S. Pat. No. 6,908,568, the molded bodies obtained by molding in a magnetic field underwent marked incidence of cracking and did not attained desired magnetic properties as the case may be. Analysis of the composition of such a La—Co based ferrite magnet revealed that, with respect to La, the composition deviated from the composition finally desired to obtain (composition deviation).

The present invention has been achieved on the basis of such technical problems as described above, and takes as its object the provision of a production method which can suppress the composition deviation when a La—Co based ferrite magnet is produced by using a polyhydric alcohol as a dispersant.

The present inventors observed the slurry for molding used for production of the La—Co based ferrite magnet exhibiting composition deviation. The observation revealed that the supernatant liquid of the slurry for molding was turbid; analysis of the solid matter responsible for this turbidity resulted in detection of a large amount of La. On the other hand, in the case of a La—Co based ferrite magnet exhibiting no composition deviation, the supernatant liquid of the slurry involved was nearly transparent. Consequently, it is understood that when the composition deviation occurred, a part of the La to be homogeneously found in the powder of the slurry for molding was separated from the powder of the slurry for molding. Investigation of the cause for this separation has indicated that the separation would be caused by the B (boron) contained as an impurity in the water used in milling in preparation of the slurry for molding and in slurry concentration adjustment. More specifically, it is understood that the B in water and polyhydric alcohol, for example, sorbitol react to each other to produce an acid, and consequently the raw material for La, for example, La(OH)₃ is separated into the supernatant liquid. In fact, decrease of the B contained in water enabled the prevention of the composition deviation.

The present invention is based on the above described investigations carried out by the present inventors; the present invention is a method for producing a ferrite sintered magnet that includes as main constituents thereof Fe, an element A (A including at least one element selected from Sr, Ba and Pb), an element R (R including at least one element selected from rare earth elements and Bi, with the proviso of inevitably including La) and an element Me (Me including Co or including Co and Zn), the production method including a molding step of obtaining a molded body by pressure molding, in a magnetic field in a predetermined direction, a slurry for molding prepared by dispersing a powder mainly composed of a ferrite in water as a dispersion medium and by adding a dispersant and a sintering step of obtaining the ferrite sintered magnet by sintering the molded body, wherein the dispersant is a polyhydric alcohol represented by the general formula Cₙ(OH)ₙHₙ₊₂, and the concentration of B in the water to be used for preparing the slurry for molding is 1 ppm or less.

In the present invention, the concentration of B in the water to be used for preparing the slurry for molding is preferably 0.7 ppm or less.

In the present invention, the concentration of B in the water to be used for preparing the slurry for molding is preferably 0.5 ppm or less.

In the present invention, the concentration of B in the water to be used for preparing the slurry for molding is preferably 0.3 ppm or less.

In the present invention, the advantageous effects of the present invention can be remarkably attained when the powder mainly composed of a ferrite is a powder obtained by adding a raw material composition involving La or a raw material composition involving La and Co to a composition obtained by calcining a prescribed raw material.

Further, in the present invention, the polyhydric alcohol is preferably sorbitol. The additive amount of sorbitol is preferably 0.05 to 5.0% by weight.

In the ferrite sintered magnet to which the present invention is applied, the element A is preferably Sr.

In the ferrite sintered magnet to which the present invention is applied, it is preferable that the element R is La.

In the ferrite sintered magnet to which the present invention is applied, the element Me is preferably Co.

When the gross constituent ratios of the metal elements are represented by a composition formula (1), Sr₁₋ₓLₓ(Fe_{12-y}Co_{y})_{z}, the ferrite sintered magnet to which the present invention is applied preferably comprises an oxide sintered body that has a composition represented by the relations that 0.04≦x≦0.9, 0.04≦y≦0.5, 0.4≦x/y≦4.0 and 0.7≦z≦1.2.

The present invention also provides a method for producing a ferrite sintered magnet, the production method comprising the steps of obtaining a calcined body by calcining a mixture that contains a Fe₂O₃ powder and a SrCO₃ powder as a raw material composition; obtaining a slurry for molding that contains the calcined body which is milled, a Fe₂O₃ powder, a La(OH)₃ powder and Co₃O₄ powder as the raw material composition, water as a dispersion medium in which the concentration of B is 1 ppm or less and sorbitol as a dispersant; obtaining a molded body by molding said slurry for molding in a magnetic field with and sintering the molded body.

In the method of producing the ferrite sintered magnet, the concentration of B in the water as a dispersion medium is preferably 0.7 ppm or less. The concentration of B in the water as a dispersion medium is more preferably 0.5 ppm or less, and furthermore preferably 0.3 ppm or less.

As described above, according to the present invention, decrease of the concentration of B in the water to be used for preparing the slurry for molding enables the suppression of the composition deviation and stable molding in a magnetic field without incidence of cracking. Also, according to the present invention, decrease of the concentration of B in the water to be used for preparing the slurry for molding enables the suppression of the composition deviation and stable production of a La—Co based ferrite magnet having high magnetic properties.

### BRIEF DESCRIPTION OF THE DRAWING

FIG. 1 shows the reaction formula for production of an acid by a reaction between a polyhydric alcohol and B in water;

FIG. 2 is a table showing the observation results of the supernatant liquid for the slurry for molding, the composition of the powder contained in the slurry for molding, and the observation results of the incidence of cracking in each of the molded bodies ( for each of the slurries for molding, 100 molded bodies were prepared) obtained by molding in a magnetic field;

FIG. 3 is a table showing the composition analysis results of the solid matter collected by centrifugally separating the supernatant liquid.

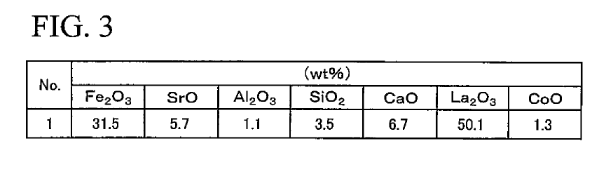

### DETAILED DESCRIPTION OF THE PREFERRED EMBODIMENTS

The present invention will be described below in detail.

First, the composition of the ferrite sintered magnet to which the present invention is applied will be described.

The ferrite sintered magnet to which the present invention is applied includes as main constituents an element A, an element R, an element Fe and an element Me wherein the element A includes at least one element selected from Sr, Ba and Pb, the element R includes at least one element selected from rare earth elements (inclusive of Y) and Bi with the proviso of inevitably including La, and the element Me includes Co or includes Co and Zn. When the gross constituent ratios of the metal elements are represented by a composition formula (1), A₁₋ₓRₓ(Fe_{12-y}Me_{y})_{z}, the ferrite sintered magnet is preferably made of an oxide sintered body that has a composition represented by the relations that 0.04≦x≦0.9, 0.04≦y≦0.5, 0.4≦x/y≦4.0 and 0.7≦z≦1.2. In the above composition formula (1), more preferred are the relations that 0.04≦x≦0.5 and 0.04≦y≦0.4, and furthermore preferred are the relations that 0.1≦x≦0.4 and 0.1≦y≦0.4.

The composition formula (1) will be described below in detail.

Element A:

The element A includes at least one element selected from Sr, Ba and Pb. As for the element A, Sr is most preferably used from the viewpoint of improving the coercive force (HcJ). The proportion of Sr in the element A is preferably 51% by atom or more, more preferably 70% by atom or more, and furthermore preferably 100% by atom. When the proportion of Sr in the element A is too low, it becomes difficult to simultaneously increase the saturation magnetization and the coercive force.

Element R(x):

When x denoting the amount of the element R is too small in the composition formula (1), the solid solution content of the element Me in relation to the M-type hexagonal ferrite cannot be made large, and consequently the improvement effect of the saturation magnetization and/or the improvement effect of the anisotropic magnetic field becomes insufficient. When x is too large, the element R cannot form a solid solution in the M-type hexagonal ferrite in a replacing manner, and consequently, for example, an orthoferrite containing the element R is generated, and the saturation magnetization is decreased. Accordingly, in the present invention, x is preferably set to fall within a range of 0.04≦x≦0.9.

The element R includes at least one element selected from rare earth elements (inclusive of Y) and Bi, and it is preferable to use La as for the element R from the viewpoint of improving the residual magnetic flux density (Br). Accordingly, La is indispensable in the present invention.

Rare earth elements are La, Ce, Pr, Nd, Sm, Eu, Gd, Tb, Dy, Ho, Er, Tm, Yb and Lu, and accordingly, the element R in the present invention includes at least one element selected from La, Ce, Pr, Nd, Sm, Eu, Gd, Tb, Dy, Ho, Er, Tm, Yb, Lu, Y and Bi.

Element Me(y):

When y denoting the amount of the element Me is too small in the composition formula (1), the improvement effect of the saturation magnetization and/or the improvement effect of the anisotropic magnetic field becomes insufficient. When y is too large, the element Me cannot form a solid solution in the M-type hexagonal ferrite in a replacing manner. Even when y falls within a range in which the element Me can form a solid solution in a replacing manner, the anisotropy constant (K1) and the anisotropic magnetic field (Ha) are largely degraded. Accordingly, in the present invention, y is preferably set to fall within a range of 0.04≦y≦0.5.

The proportion of Co in the element Me is preferably 20% by atom or more, more preferably 50% by atom or more, and furthermore preferably 100% by atom. When the proportion of Co in the element Me is too low, the coercive force improvement becomes insufficient.

z:

When z is too small in the composition formula (1), the proportion of the nonmagnetic phase containing Sr and the element R is increased, and the saturation magnetization is thereby decreased. When z is too large, the α-Fe₂O₃ phase or the nonmagnetic spinel ferrite phase containing the element Me is increased, and hence the saturation magnetization is decreased. Accordingly, in the present invention, z is preferably set to fall within a range of 0.7≦z≦1.2.

When x/yz is either too small or too large in the composition formula (1), the valency balance between the element R and the element Me can hardly be attained, and the hetero-phase such as the W-type ferrite tends to be easily generated. When the element Me provides divalent ions and the element R provides trivalent ions, it is general to make the relation x/yz=1 be satisfied from the viewpoint of the valency balance; however, a high saturation magnetization and a high coercive force can be made compatible when x/yz falls within a range from 1 to 1.5.

The composition formula (1) represents the gross constituent ratios of the respective metal elements, A, R, Fe and Me; however, the composition formula inclusive of oxygen O can be represented by A₁₋ₓRₓ(Fe_{12-y}Me_{y})_{z}O₁₉. Here, the number of the atoms of oxygen O is set at 19, and the number of 19 refers to the stoichiometric composition ratio of oxygen for the case in which Me is exclusively divalent, Fe and R are all trivalent, and x=y and z=1; the number of the atoms of oxygen O is varied depending on the values of x, y and z. For example, when the sintering atmosphere is a reductive atmosphere, there is a possibility of oxygen defect (vacancy) formation. In the M-type hexagonal ferrite, Fe is usually present to be trivalent, but there is a possibility that Fe is converted to be divalent; there is also a possibility that Co and/or Me is varied in valency, and further, there is a possibility that R has a valency (or valencies) other than 3. Accordingly, the proportion of oxygen in relation to the metal elements is varied depending on these variations in valencies. In the above description, and also in Examples to be presented later, the number of the atoms of oxygen O is presented to be 19 irrespective of the values of x, y and z; however, the actual number of the atoms of oxygen O is somewhat deviated from this value as the case may be, and such cases also fall within the scope of the present invention.

The ferrite sintered magnet according to the present invention may include as additives a Si constituent and a Ca constituent. The Si constituent and the Ca constituent are added for the purposes of improving the sinterability, controlling the magnetic properties, and regulating the grain size of the sintered body of the M-type hexagonal ferrite, and for the like purposes.

It is preferable that SiO₂ and CaCO₃ are used as the Si constituent and the Ca constituent, respectively; however, the Si and Ca constituents are not limited to these examples, and other compounds may be optionally used. Preferably, the additive amount of the Si constituent is 0.15 to 1.35% by weight in terms of SiO₂ and the ratio of the molar quantity of the Ca constituent to the molar quantity of the Si constituent Ca/Si is 0.35 to 2.10; and more preferably, the additive amount of the Si constituent is 0.30 to 0.90% by weight in terms of SiO₂ and the ratio Ca/Si is 0.70 to 1.75.

The ferrite sintered magnet of the present invention may include Al₂O₃ and/or Cr₂O₃ as additives. Al₂O₃ and/or Cr₂O₃ improves the coercive force but degrades the residual magnetic flux density. The content of Al₂O₃ and/or Cr₂O₃ is preferably set at 3.0% by weight or less for the purpose of suppressing the degradation of the residual magnetic flux density. For the purpose of fully attaining the addition effect of Al₂O₃ and/or Cr₂O₃, the content of Al₂O₃ and/or Cr₂O₃ is preferably set at 0.1% by weight or more.

The ferrite sintered magnet of the present invention preferably does not include alkali metal elements such as Na, K and Rb, but may include such alkali metal elements as impurities. When the contents of these alkali metal elements are derived in terms of the oxides such as Na₂O, K₂O and Rb₂O, the sum of these contents is preferably 3.0% by weight or less of the whole ferrite sintered magnet. When these contents are too large, the saturation magnetization becomes low.

In addition to the above, the ferrite sintered magnet of the present invention may include, for example, Ga, Mn, Ni, Cu, In, Li, Mg, Ti, Zr, Ge, Sn, V, Nb, Ta, Sb, As, W and Mo as oxides. The contents of these elements in terms of the oxides having stoichiometric compositions are preferably as follows: gallium oxide: 5.0% by weight or less; manganese oxide: 3.0% by weight or less; nickel oxide: 3.0% by weight or less; copper oxide: 3.0% by weight or less; indium oxide: 3.0% by weight or less; lithium oxide: 1.0% by weight or less; magnesium oxide: 3.0% by weight or less; titanium oxide: 3.0% by weight or less; zirconium oxide: 3.0% by weight or less; germanium oxide: 3.0% by weight or less; tin oxide: 3.0% by weight or less; vanadium oxide: 3.0% byweight or less; niobium oxide: 3.0% by weight or less; tantalum oxide: 3.0% by weight or less; antimony oxide: 3.0% by weight or less; arsine oxide: 3.0% byweight or less; tungsten oxide: 3.0% byweight or less; and molybdenum oxide: 3.0% by weight or less.

The mean grain size of the ferrite sintered magnet of the present invention is preferably 1.5 μm or less, more preferably 1.0 μm or less, and furthermore preferably 0.2 to 1.0 μm. The grain sizes can be measured with a scanning electron microscope.

The ferrite sintered magnet according to the present invention is processed into predetermined shapes, and used in the following wide applications. For example, the magnet can be used as motors for vehicles which drive a fuel pump, a power window, an ABS (antilock break system), a fan, a wiper, a power steering, an active suspension, a starter, a door lock, an electric mirror, or the like. Moreover, the magnet can also be used as motors for office automation/audio-video equipment, which drive an FDD spindle, a VTR capstan, a VTR rotating head, a VTR reel, a VTR loading, a VTR camera capstan, a VTR camera rotating head, a VTR camera zoom, a VTR camera focus, a radio cassette capstan, a CD/DVD/MD spindle, a CD/DVD/MD loading, a CD/DVD light pickup, or the like. Furthermore, the magnet can also be used as motors for household electrical appliances, which drive an air conditioner compressor, a refrigerator compressor, an electric tool, a drier fan, a shaver, an electric toothbrush, or the like. Still further, the magnet can also be used as motors for factory automation equipment, which drive a robot axis, a joint, a robot, a machine tool table, a machine tool belt, or the like. As other applications, the magnet can also preferably be used for a motorcycle generator, a magnet used for speakers/headphones, a magnetron tube, a magnetic field generator for MRI, a CD-ROM clamper, a sensor for distributors, a sensor for ABS, a fuel/oil level sensor, a magnet latch, an isolator, or the like.

Next, a preferable method for producing the ferrite sintered magnet of the present invention will be described.

The method for producing the ferrite sintered magnet of the present invention includes a mixing step, a calcining step, a pulverizing/milling step (a pulverizing step, a milling step) a step of wet molding in a magnetic field and a sintering step.

<Mixing Step>

In the mixing step, each of the raw material powders are weighed out so as to satisfy predetermined proportions, and then mixed and milled for approximately 1 to 20 hours using a wet attrition mill, a ball mill or the like. As the starting raw materials, there may be used compounds containing one or more of the ferrite constituting elements (Fe, the element A, the element R, the element Me and the like). As such compounds, there are used oxides or compounds to be converted into oxides by sintering such as carbonates, hydroxides and nitrates. In addition to the ferrite constituting elements, SiO₂, CaCO₃, Al₂O₃ and the like are added as additives as the case may be. No particular constraints are imposed on the mean particle sizes of the starting raw materials, but usually, the mean particle sizes are preferably set to be approximately 0.1 to 2.0 μm. Not all of the starting raw materials are required to be mixed in the mixing step before calcination, but a part or the whole of each of the compounds may be added after calcination. For example, it is preferable that a part or the whole of each of the element R including La and the element Me including Co undergoes posterior addition. Here, it should be noted that in the present specification the addition operation before the calcining step will be referred to as the anterior addition and the addition operation after the calcining step will be referred to as the posterior addition.

<Calcining Step>

The raw material composition obtained in the mixing step is calcined. The calcination is usually carried out in an oxidative atmosphere such as in air. The calcination conditions are not particularly limited, but usually the stable temperature maybe set at 1000 to 1450° C., and the stable period of time may be set at 1 second to 10 hours. The main phase of the calcined body has a magnetoplumbite (M) type ferrite structure, and the primary particle size thereof is preferably 2 μm or less and more preferably 1 μm or less.

<Pulverizing/Milling Step>

The calcined body is usually granular or agglomerate, and cannot be molded as it is into a desired shape. Consequently, the calcined body is pulverized/milled. The pulverizing/milling step is necessary for the purpose of mixing the raw material powders, additives and the like for the composition to be adjusted to the desired final composition. The addition of the raw material powders and the like in the present step is the posterior addition. As described above, it is preferable to add the element R and the element Me in the pulverizing/milling step for the purpose of improving the magnetic properties. The pulverizing/milling step is divided into a pulverizing step and a milling step, and it is preferable to carry out the posterior addition before the milling step.

<Pulverizing Step>

As described above, the calcined body is usually granular or agglomerate, and preferably pulverized. In the pulverizing step, a vibration mill is used, and the treatment is continued until the mean particle size becomes 0.5 to 10 μm. Here, it is to be noted that the powder obtained here will be referred to as the pulverized powder.

<Milling Step>

The pulverized powder is milled with a wet attrition mill or a ball mill until the mean particle size becomes approximately 0.08 to 2 μm, preferably 0.1 to 1 μm and more preferably 0.2 to 0.8 μm. The milling step is carried out for the purposes of making coarse and large particles disappear, fully mixing the posterior additives, making fine the grains of the sintered body in order to improve the magnetic properties, and performing the like. The specific surface area (obtained on the basis of the BET method) of the obtained milled powder is preferably made to be approximately 7 to 12 m²/g. The milling time depends on the particular milling method, and the milling treatment may be carried out for approximately 30 minutes to 10 hours with a wet attrition mill and for approximately 10 to 40 hours in a wet milling with a ball mill.

As described above, in the present invention, the posterior additives are preferably added in the milling step. Also, in the present invention, for the purpose of increasing the magnetic orientation degree of the sintered body, a polyhydric alcohol represented by the general formula Cₙ(OH)ₙHₙ₊₂ is preferably added in the milling step. In this general formula, n representing the number of carbon atoms is preferably 4 to 100, more preferably 4 to 30, furthermore preferably 4 to 20 and yet furthermore preferably 4 to 12. As the polyhydric alcohol, for example, sorbitol, mannitol and xylitol are preferable, and sorbitol (n:6) is particularly preferable. Two or more types of polyhydric alcohols may be used in combination. Further, in addition to the polyhydric alcohols used in the present invention, other dispersants well known in the art may also be added.

The above described general formula for the polyhydric alcohol refers to the case in which the skeleton is exclusively of a straight chain and does not include any unsaturated bond. The number of the hydroxyl groups and the number of the hydrogen atoms in the polyhydric alcohol may be somewhat smaller than those indicated by the general formula. In other words, the polyhydric alcohol may include one or more unsaturated bonds as well as the saturated bonds. The fundamental skeleton of the polyhydric alcohol may be either of a straight chain or cyclic, but is preferably of a straight chain. When the number of the hydroxyl groups is 50% or more of the number n of the carbon atoms, the advantageous effects of the present invention can be attained, but the larger number of the hydroxyl groups is more preferable, and it is most preferable that the number of the hydroxyl groups is approximately the same as the number of the carbon atoms. The additive amount of the polyhydric alcohol may be set to be approximately 0.05 to 5.0% by weight, preferably approximately 0.1 to 3.0% by weight, and more preferably approximately 0.3 to 2.0% by weight in relation to the object of the addition. It may be noted that the added polyhydric alcohol is thermally decomposed to be removed in the sintering step to be carried out after the step of molding in a magnetic field.

The milling step is also a step of preparing a slurry for the wet molding in a magnetic field to be carried out later. Specifically, when wet molding is carried out, the milling step is carried out in a wet process, the obtained slurry is concentrated, and the concentrated slurry is adjusted so as to have a predetermined concentration, if needed, to yield a slurry for wet molding. Concentration may be carried out with a centrifugal separator, a filter press or the like. In this case, it is preferable that the milled powder accounts for approximately 30 to 80% by weight of the slurry for wet molding.

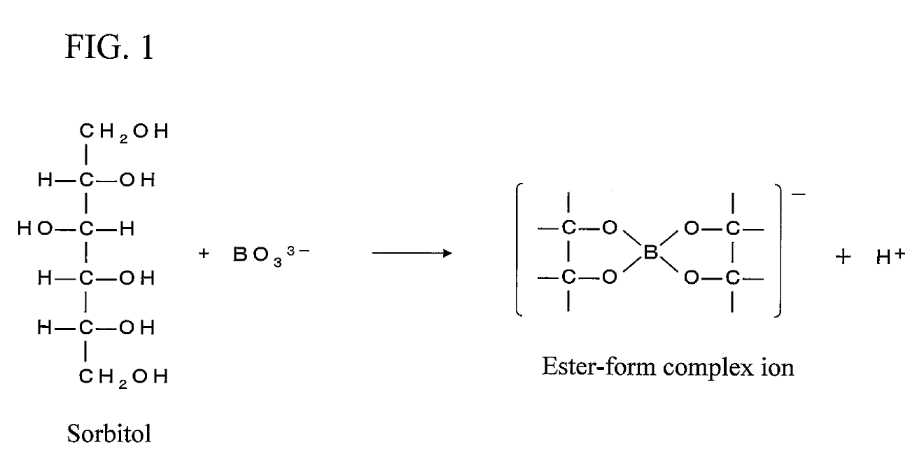

The present invention is characterized by regulating to be 1 ppm or less the concentration of B contained in the water to be used in the individual steps of preparing the slurry for molding such as milling and adjustment of the concentration of the slurry. When the concentration of B exceeds 1 ppm, the composition deviation, in particular, the composition deviation for La is generated at the stage of the molded body to hinder the moldability and it becomes difficult to obtain desired magnetic properties. As described above, the polyhydric alcohol added as a dispersant and the B contained in the water react with each other to produce an acid. When sorbitol is used as the polyhydric alcohol, the formula representing the reaction to produce the acid is as shown in FIG. 1. The acid is selectively adsorbed to, for example, La(OH)₃ that is the raw material of La, and hence the dispersibility is largely varied. As a result, La(OH)₃ is separated from the powder in the slurry for molding. The separated La(OH)₃ is present in a large amount in the supernatant liquid of the slurry for wet molding. When the wet molding in a magnetic field is carried out under this condition, the moldability is degraded. The separated La(OH)₃ is partially discharged from the system in the concentration step of the slurry for molding and the step of molding in a magnetic field, and hence the sintered body obtained by sintering the molded body suffers the deviation of the La content toward a value lower than the desired content. Consequently, the magnetic properties are degraded. Accordingly, in the present invention, the content of B contained in the water to be used in the respective steps involved in the preparation of the slurry for molding such as milling and adjustment of the slurry concentration is set at 1 ppm or less, preferably 0.7 ppm or less, more preferably 0.5 ppm or less, furthermore preferably 0.3 ppm or less, and most preferably 0.1 ppm or less.

<Step of Molding in a Magnetic Field>

Next, molding in a magnetic field is carried out with the slurry for molding. The molding pressure may be approximately 0.1 to 0.5 ton/cm², and the applied magnetic field may be approximately 5 to 15 kOe.

As described above, if La is present in a large amount in the supernatant liquid of the slurry for molding, the supernatant liquid is turbid; such a slurry for molding is poor in dehydration during molding, and accordingly cracking tends to occur in the molded body. The present invention suppresses the turbidity of the supernatant liquid by reducing the concentration of B in the water to be used in preparation of the slurry for molding to ensure a satisfactory moldability.

<Sintering Step>

The molded body thus obtained is sintered to yield a sintered body. The sintering is usually carried out in an oxidative atmosphere such as in air. No particular constraints are imposed on the sintering conditions; however, for example, usually the temperature increase may be made at a rate of approximately 5° C./min, and the stable temperature may be set preferably at 1100 to 1300° C. and more preferably at 1150 to 1250° C., and the stable period of time is set to be approximately 0.5 to 3 hours. When the molded body has been obtained by wet molding, if the molded body is not sufficiently dried and is rapidly heated as it is, there is a possibility that cracking is caused in the molded body. When wet molding has been applied, it is preferable to suppress the incidence of cracking by sufficiently drying the molded body by increasing the temperature from room temperature to approximately 100° C. in such a way that the temperature increase rate is set to be as slow as, for example, approximately 10° C./hour. When a dispersant is added as in the present invention, it is preferable to sufficiently remove the dispersant by carrying out a degreasing treatment within a temperature range approximately from 100 to 500° C. in such a way that the temperature increase rate is set to be, for example, approximately 2.5° C./min.

### EXAMPLE

As the starting materials, a Fe₂O₃ powder, a SrCO₃ powder, a SiO₂ powder and a CaCO₃ powder were used. A raw material composition was obtained from these raw material powders in such a way that the Fe₂O₃ powder and the SrCO₃ powder were weighed out so as for the ratio between Fe and Sr to be a predetermined value (molar ratio), and the SiO₂ powder and the CaCO₃ powder were further added to the mixture thus obtained. The raw material composition thus obtained was wet mixed with an attrition mill, then dried and sized, and calcined in a rotary kiln at 1200 to 1310° C. for 2 hours to yield a granular calcined body.

The obtained calcined body was pulverized with an vibration mill, then added with the Fe₂O₃ powder, a La(OH)₃ powder and a Co₃O₄ powder so as to have a composition represented by Sr_{0.766}La_{0.234}Fe_{11.8}Co_{0.2}O₁₉, and also with the SiO₂ powder, the CaCO₃ powder, an Al₂O₃ powder and sorbitol to be milled with an attrition mill. The milling was carried out by using water as a dispersion medium under the conditions of being slurry. It is to be noted that there were used two or more types of water different from each other in the concentration of B to prepare two or more slurries. The additive amount of sorbitol in relation to the pulverized powder was set at 0.5% by weight.

Each of the milled slurries was dehydrated with a filter press, and then kneaded with a kneader ruder; in this kneading, the solid content concentration in the slurry for molding was regulated to be 75% by weight.

The slurry for molding was injected into a die, and molded by compression while being dehydrated. The molding was carried out by applying a magnetic field of approximately 10 kOe (800 kA/m) along the direction of compression.

The molded body thus obtained was sintered with a temperature increase/decrease rate of 5° C./min and a retention at 1200° C. for 1 hour to yield a sintered body.

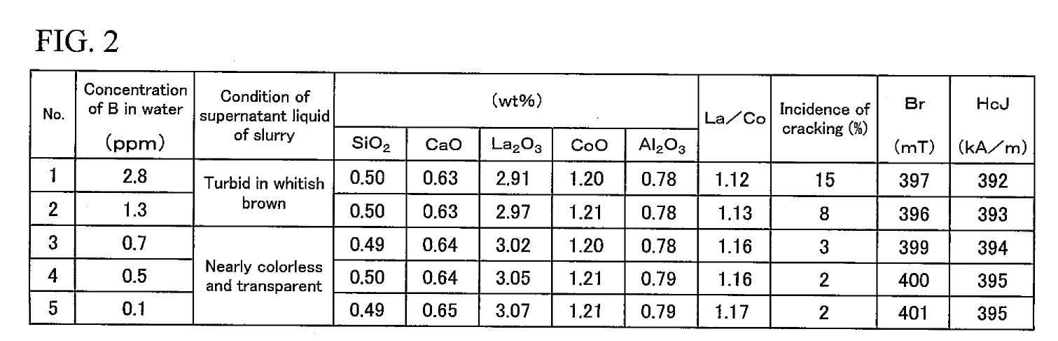

In the course of the process to complete the preparation of each of the sintered bodies, the supernatant liquid of the slurry for molding was observed and the composition of the slurry for molding was analyzed with respect to the powders included therein by means of X-ray fluorescence analysis; the analysis values for Fe and Sr are not presented. The analysis values are all presented in terms of the corresponding oxides. The incidence of cracking in each of the molded bodies (for each of the slurries for molding, 100 molded bodies were prepared) obtained by molding in a magnetic field was observed. Further, the magnetic properties of each of the sintered bodies were measured. The results thus obtained are shown in FIG. 2.

As can be seen from FIG. 2, when the concentration of B in the water used for preparation of a slurry for molding is high, the supernatant liquid of the slurry for molding becomes turbid with whitish brown. The solid matter collected by centrifugally separating the supernatant liquid turbid with whitish brown was analyzed. The results obtained are shown in Table 3, and as can be seen from Table 2, La(OH)₃ was present in a high concentration (the analysis value concerned is presented in terms of La₂O₃; this is also the case in what follows). On the other hand, as can be seen from Table 2 when the compositions included in the molded bodies are compared with each other, as the concentration of B in the water was increased, the amount of La(OH)₃ was decreased. Consequently, it was observed that La (OH)₃ was separated from the milled powder and La(OH)₃ thus separated was contained in a large amount in the supernatant liquid of the slurry for wet molding.

The amount of CoO in the powder of the slurry for molding was nearly constant even when the concentration of B in water was varied. Consequently, the molar ratio of La to Co, namely, La/Co was varied depending on the concentration of B in the water used for preparation of the slurry for molding. In present Example, the target value of La/Co was 1.17, and when the deviation value of La/Co from this value became large, the degradation of the magnetic properties became remarkable. As the concentration of B in the water of the slurry for molding was decreased and the La/Co value got closer to 1.17, both of the actually measured residual magnetic flux density (Br) and coercive force (HcJ) each showed a high value.

When the incidences of cracking of the molded bodies are examined, the concentration of B in the water to be used for each of the slurries for molding is high and the supernatant liquid thereof is turbid, the incidence of cracking can be seen to increase. This is because the solid matter responsible for the turbidity of the supernatant liquid degrades the dehydration when molding in a magnetic filed.

As described above, by regulating the concentration of B in the water to be used for preparing the slurry for wet molding, the incidence of cracking in the molded body based on wet molding can be reduced, and by suppressing the composition deviation in the molded body, ultimately in the sintered body, high magnetic properties can also be attained.

What is claimed is:

1. A method for producing a ferrite sintered magnet that comprises as main constituents thereof Fe, an element A (A comprising at least one element selected from Sr, Ba and Pb), an element R (R comprising at least one element selected from rare earth elements and Bi, and comprising La as an essential constituent) and an element Me (Me comprising Co or comprising Co and Zn), the production method comprising:
a molding step of obtaining a molded body by pressure molding, in a magnetic field in a predetermined direction, a slurry for molding prepared by dispersing a powder mainly comprising a ferrite in water as a dispersion medium and by adding a dispersant; and
a sintering step of obtaining the ferrite sintered magnet by sintering said molded body; wherein said dispersant is a polyhydric alcohol represented by the general formula Cₙ(OH)ₙHₙ₊₂; and
the concentration of B in the water to be used for preparing said slurry for molding is 1 ppm or less.

2. The method for producing a ferrite sintered magnet according to claim 1, wherein said powder mainly comprising a ferrite is a powder obtained by adding a raw material composition involving La or a raw material composition involving La and Co to a composition obtained by calcining a prescribed raw material.

3. The method for producing a ferrite sintered magnet according to claim 1, wherein the concentration of B in the water to be used for preparing said slurry for molding is 0.7 ppm or less.

4. The method for producing a ferrite sintered magnet according to claim 1, wherein the concentration of B in the water to be used for preparing said slurry for molding is 0.5 ppm or less.

5. The method for producing a ferrite sintered magnet according to claim 1, wherein the concentration of B in the water to be used for preparing said slurry for molding is 0.3 ppm or less.

6. The method for producing a ferrite sintered magnet according to claim 1, wherein said polyhydric alcohol is sorbitol.

7. The method for producing a ferrite sintered magnet according to claim 6, wherein the additive amount of said sorbitol is 0.05 to 5.0% by weight.

8. The method for producing a ferrite sintered magnet according to claim 1, wherein said element A is Sr.

9. The method for producing a ferrite sintered magnet according to claim 1, wherein said element R is La.

10. The method for producing a ferrite sintered magnet according to claim 1, wherein said element Me is Co.

11. The method for producing a ferrite sintered magnet according to claim 1, wherein the ferrite sintered magnet comprises an oxide sintered body that has a composition represented by the relations that;
0.04≦x≦0.9,
0.04≦y≦0.5,
0.4≦x/y≦4.0, and
0.7≦z≦1.2,
when the gross constituent ratios of the metal elements are represented by a composition formula (1);
Sr₁₋ₓLaₓ(Fe_{12-y}Co_{y})_{z}.

12. The method for producing a ferrite sintered magnet wherein the method comprising the steps of;
obtaining a calcined body by calcining the mixture including a Fe₂O₃ powder and a SrCO₃ powder as a raw material composition;
obtaining a slurry for molding that includes the calcined body which is milled, a Fe₂O₃ powder, a La(OH)₃ powder and a Co₃O₄ powder as a raw material composition, water as a dispersion medium in which the concentration of B is 1 ppm or less and sorbitol as a dispersant;
obtaining a molded body by molding said slurry for molding in a magnetic field, and
sintering said molded body.

13. The method for producing a ferrite sintered magnet according to claim 12, wherein the concentration of B in water as said dispersion medium is 0.7 ppm or less.

14. The method for producing a ferrite sintered magnet according to claim 12, wherein the concentration of B in water as said dispersion medium is 0.5 ppm or less.

15. The method for producing a ferrite sintered magnet according to claim 12, wherein the concentration of B in water as said dispersion medium is 0.3 ppm or less.
